(19) United States
(12) Patent Application Publication
(10) Pub. No.: US 2015/0184626 A1
(43) Pub. Date: Jul. 2, 2015

(54) Method and Device for Controlling an Injection Process Comprising a Pre-Injection and a Main Injection

(71) Applicant: Continental Automotive GmbH, Hannover (DE)

(72) Inventor: Frank Denk, Obertraubling (DE)

(73) Assignee: Continental Automotive GmbH, Hannover (DE)

(21) Appl. No.: 14/418,214

(22) PCT Filed: Jul. 29, 2013
(86) PCT No.: PCT/EP2013/065912

§ 371 Date: Jan. 29, 2015

(30) Foreign Application Priority Data
Aug. 6, 2012 (DE) 10 2012 213 883.8

(51) Int. Cl. F02M 51/06; F02D 41/30

(52) U.S. Cl. CPC F02M 51/061; F02D 41/30

(57) ABSTRACT

A method for adapting a current profile for a multi-injection process by a fuel injector includes applying to a coil a first excitation profile causing a first multi-injection in which two sub-injection processes are separated such that the fuel injector completely closes in the meantime, determining the closing point of the fuel injector, calculating a minimally possible separation time between the end of the excitation for a first sub-injection process and the beginning of the excitation for a second sub-injection process for a second multi-injection, the fuel injector completely closing between the two sub-injection processes, applying to the coil a second excitation profile leading to the second multi-injection, determining a current intensity rise time during a boost phase of the second sub-injection process, and applying to the coil a third electric excitation profile having a pre-charge phase that pre-magnetizes the coil drive, for each sub-injection process.

### CROSS-REFERENCE TO RELATED APPLICATIONS

This application is a U.S. National Stage Application of International Application No. PCT/EP2013/065912 filed Jul. 29, 2013, which designates the United States of America, and claims priority to DE Application No. 10 2012 213 883.8 filed Aug. 6, 2012, the contents of which are hereby incorporated by reference in their entirety.

### TECHNICAL FIELD

The present invention relates to the technical field of the actuation of fuel injectors which comprise a magnetic armature, which is mechanically coupled to a valve needle, and a coil drive comprising a coil, for moving the magnetic armature. The present invention relates, in particular, to a method, a device, an engine controller and a computer program for adapting the time profile of a current which flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least a boost phase and a freewheeling phase.

### BACKGROUND

During operation, in particular of directly driven fuel injectors which comprise a magnetic armature, which is mechanically coupled to a valve needle, and a coil drive, comprising a coil, for moving the magnetic armature, with the same current/voltage parameters, different chronological opening and/or closing behavior of the individual fuel injectors occurs owing to electrical, magnetic and/or mechanical tolerances. This leads in turn to undesired injector-specific variations in terms of the quantity of the actually injected fuel.

However, the relative injection quantity differences from one fuel injector to another increase as the injection times become shorter and therefore at small injection quantities. For modern engines it is already important, and for future generations of engines it will be even more important in view of a further reduction in the emission of pollutants, that a high level of quantity accuracy can be ensured even at low fuel quantities to be injected. However, a high level of quantity accuracy can be achieved only when the actual movement behavior of the valve needle or of the magnetic armature is known, in particular, during the opening process and/or during the closing process. Only then can injector-specific variations in terms of the quantity of the actually injected fuel be compensated by suitable injector-specific adaptation of the electrical actuation of a respective fuel injector.

The coil current which is required to operate a fuel injector comprising a coil drive is typically made available by a suitable current regulating device, frequently known for short as current regulator hardware. In this context, a very rapidly rising current flow through the coil of the coil drive of the respective fuel injector is typically generated during the start of the injection process using what is referred to as a boost voltage. This occurs until a predefined peak current is reached, said peak current defining the end of what is referred to as the boost phase. The time profile which is obtained for the current through the coil of the coil drive is dependent here, inter alia, on the inductivity and the real electrical resistance of the coil. In the case of what are referred to as multiple injections, the time profile which is obtained for the current also depends on the time interval between the various electrical actuations of the corresponding opening process.

The real electrical resistance is composed of the ohmic resistance of the winding or windings of the coil and the electrical resistance of the (ferro)magnetic material of the fuel injector. Eddy currents, which are induced on the basis of magnetic changes in flux in the ferromagnetic material, are damped by the finite electrical resistance of the (ferro)magnetic material and converted into heat.

This makes a further contribution to the real ohmic losses. Both the ohmic resistance of the winding or windings of the coil and the resistance of the (ferro)magnetic material of the fuel injector exhibit a temperature dependence, with the result that the time profile which is obtained for the current also depends on the temperature.

### SUMMARY

One embodiment provides a method for adapting the time profile of a current which flows through a coil of a coil drive of a fuel injector and which brings about multiple injection of fuel with at least two partial injection processes during the operation of an internal combustion engine of a motor vehicle, wherein the time profile of the current for each partial injection process comprises at least one boost phase and one freewheeling phase, the method comprising: supplying the coil with a first electrical excitation profile which brings about a first multiple injection in which two successive partial injection processes are chronologically separated from one another to such an extent that the fuel injector closes completely between the two partial injection processes; determining the closing time of the fuel injector for the first partial injection process of the first multiple injection; calculating, for a second multiple injection, a minimum possible separation time between (i) the end of the electrical excitation for a first partial injection process and (ii) the start of the electrical excitation for a subsequent second partial injection process, wherein the fuel injector just still completely closes between the two partial injection processes; supplying the coil with a second electrical excitation profile which brings about the second multiple injection with at least the first partial injection process and the second partial injection process; determining the rise time of the current intensity during the boost phase of the second partial injection process of the second multiple injection; identifying the determined rise time as a minimum rise time which can be achieved by the respective fuel injector; and supplying the coil with a third electrical excitation profile which brings about a third multiple injection with at least two partial injection processes; wherein the third electrical excitation profile for each partial injection process comprises a pre-charge phase by means of which the coil drive is pre-magnetized; and wherein the electrical excitation is dimensioned during the respective pre-charge phase in such a way that the rise times within the third electrical excitation profile for the boost phases of the at least two partial injection processes of the third multiple injection are at least approximately the same as the identified minimum rise time.

In a further embodiment, the third electrical excitation profile for each partial injection process comprises equally long electrical actuation which starts with the start of the respective boost phase.

In a further embodiment, the electrical excitation during the respective pre-charge phase is also dimensioned in such a way that at the time of the end of the electrical actuation for each partial injection process, said actuation being equally long for each partial injection process, an equally high residual current level of the profile of the current through the coil is provided.

In a further embodiment, the separation time between two successive electrical actuations, which are equally long, in the third electrical excitation profile is equal to the minimum possible separation time calculated for the second multiple injection.

In a further embodiment, the determination of the closing time of the fuel injector for the first partial injection process occurs by means of an evaluation of electrical signals which are present at the coil.

In a further embodiment, the electrical excitation during the respective pre-charge phase comprises supplying the coil with a voltage which is made available by a battery of the motor vehicle.

In a further embodiment, the electrical excitation at least during the start of the respective pre-charge phase comprises supplying the coil with a boost voltage which is increased compared to the voltage made available by a battery of the motor vehicle.

In a further embodiment, the supplying of the coil with the first electrical excitation profile is carried out at the start of a driving cycle of the motor vehicle.

In a further embodiment, the method further comprises: determining the closing time of the fuel injector for the first partial injection process of the third or of a further multiple injection; and if the determined closing time of the fuel injector for the first partial injection process of the third or of a further multiple injection occurs earlier than the determined closing time of the fuel injector for the first partial injection process of the first multiple injection, calculating, for a subsequent multiple injection, an updated minimum possible separation time between (a) the end of the electrical excitation for a first partial injection process and (b) the start of the electrical excitation for a subsequent second partial injection process, in which the fuel injector still just completely closes between the two partial injection processes; supplying the coil with a subsequent electrical excitation profile which brings about the subsequent multiple injection with at least the first partial injection process and the second partial injection process; determining an updated rise time of the current intensity during the boost phase of the second partial injection process of the subsequent multiple injection; identifying the determined updated rise time as an updated minimum rise time which can be achieved by the respective fuel injector; and supplying the coil with a further subsequent electrical excitation profile which brings about a further subsequent multiple injection with at least two partial injection processes; wherein the further subsequent electrical excitation profile for each partial injection process comprises a further subsequent pre-charge phase by means of which the coil drive is pre-magnetized; and wherein the electrical excitation during the respective further subsequent pre-charge phase is dimensioned in such a way that the rise times within the further subsequent electrical excitation profile for the boost phases of the at least two partial injection processes of the further subsequent multiple injection are at least approximately the same as the identified updated minimum rise time.

Another embodiment provides a device for adapting the time profile of a current which flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least one boost phase and one freewheeling phase, the device comprising: a current regulating device (a) for supplying the coil with a voltage and (b) for regulating the current flowing through the coil; and a data processing unit which is coupled to the current regulating device; wherein the current regulating device and the data processing unit are configured to carry out the method as disclosed above.

Another embodiment provides an engine controller for an internal combustion engine of a motor vehicle, the engine controller comprising a device as disclosed above for adapting the time profile of a current.

Another embodiment provides a computer program for adapting the time profile of a current which flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least one boost phase and one freewheeling phase, wherein the computer program is configured, when executed by a processor, to carry out the method disclosed above.

### BRIEF DESCRIPTION OF THE DRAWINGS

Example embodiments of the present invention are discussed below with reference to the drawings, in which:

FIG. 1 shows, according to one embodiment, a device for adapting the time profile of a current which flows through a coil of a coil drive of a fuel injector;

FIG. 2 shows a time profile of a current I through a coil drive of a fuel injector which brings about two chronologically successive partial injection processes which are each characterized by a characteristic profile of a fuel input MFF and which are chronologically spaced apart from one another in such a way that the fuel injector closes for a time period Δt close between the two partial injection processes;

FIG. 3 shows a time profile of a current I through a coil drive of a fuel injector, wherein a separation time between two current (partial) profiles which are each assigned to a partial injection process is dimensioned in such a way that the fuel injector closes only for a short time between the two partial injection processes; and

FIG. 4 shows a time profile of a current I through a coil drive of a fuel injector, wherein equalization of the individual partial injection processes in relation to the respective fuel inputs is achieved by adapted pre-charge phases before the actual electrical actuation of the coil drive.

### DETAILED DESCRIPTION

Embodiments of the present invention are based on the object of optimizing an equalization of the electrical excitation of a coil of a coil drive of a fuel injector for various partial injection processes of a multiple injection.

One embodiment provides a method for adapting the time profile of a current is described, which current flows through a coil of a coil drive of a fuel injector and which brings about multiple injection of fuel with at least two partial injection processes during the operation of an internal combustion engine of a motor vehicle, wherein the time profile of the current for each partial injection process comprises at least one boost phase and one freewheeling phase. The described method comprises (a) supplying the coil with a first electrical excitation profile which brings about a first multiple injection in which two successive partial injection processes are chronologically separated from one another to such an extent that the fuel injector closes completely between the two partial injection processes, (b) determining the closing time of the fuel injector for the first partial injection process of the first multiple injection, (c) calculating, for a second multiple injection, a minimum possible separation time between (i) the end of the electrical excitation for a first partial injection process and (ii) the start of the electrical excitation for a subsequent second partial injection process, wherein the fuel injector just still completely closes between the two partial injection processes, (d) supplying the coil with a second electrical excitation profile which brings about the second multiple injection with at least the first partial injection process and the second partial injection process, (e) determining the rise time of the current intensity during the boost phase of the second partial injection process of the second multiple injection, (f) identifying the determined rise time as a minimum rise time which can be achieved by the respective fuel injector, and (g) supplying the coil with a third electrical excitation profile which brings about a third multiple injection with at least two partial injection processes. The third electrical excitation profile for each partial injection process comprises a pre-charge phase by means of which the coil drive is pre-magnetized, and the electrical excitation is dimensioned during the respective pre-charge phase in such a way that the rise times within the third electrical excitation profile for the boost phases of the at least two partial injection processes of the third multiple injection are at least approximately the same as the identified minimum rise time.

The described adaptation method is based on the realization that by using an adapted third electrical excitation profile each partial injection process of the third multiple injection is assigned a boost phase which is of equal length and as short as possible for the respective fuel injector.

The time period of this boost phase, which is determined by the above mentioned (minimum) rise time of the current intensity through the coil of the coil drive has, in fact, a direct influence on the quantity of fuel which is injected with the respective partial injection process from the fuel injector into the combustion chamber of an internal combustion engine. This relationship has been recognized by the inventor of the invention described in this document. As a result, by suitable adaptation of the electrical excitation of the coil it is possible to ensure that the fuel quantities which are injected with each partial injection process during a multiple injection are approximated to one another. This has in turn the result that the quantity accuracy of the fuel injection during multiple injections can be significantly improved.

The electrical excitation during the respective pre-charge phase can be adapted by suitable adaptation of the duration of the respective pre-charge phase and/or the intensity of the electrical excitation (voltage level and/or current intensity) during the respective pre-charge phase.

To put it clearly, in the case of equally long boost phases or time periods (rise times) until a predefined peak current is achieved, which determines the end of the boot phase and the start of what is referred to as the freewheeling phase, identical values for the time integrals with respect to the fuel quantity input (=injected fuel quantity per time unit) are obtained during the opening behavior of the fuel injector for all the partial injection processes of a multiple injection. As a result, by approximating the rise times to the minimum rise time which can be achieved by the respective fuel injector it is possible to achieve effective approximation or equalization of the fuel quantities for each partial injection process.

In this context it is to be noted that the variation in the fuel quantity input after the boost phase, i.e. during the freewheeling phase and a possibly following holding phase including the time period which is required for the (hydraulic) closing of the fuel injector, is relatively small compared to the variation in the fuel quantity input during the opening of the fuel injector during the boost phase. Therefore, a relatively accurate approximation of the respectively injected quantity of fuel can already be obtained in an effective way by approximating the opening behavior for various partial injection processes. This clearly means that by equalizing the time profile of the current through the coil of the coil drive of the fuel injector a different opening behavior of the respective fuel injector can be compensated and therefore the fuel quantity injected with each partial injection process can be approximated to the quantities of the other partial injection processes. This approximation is also referred to in this document as equalization.

The term rise time is to be understood in this document as meaning that time period within which the current intensity of the current through the coil rises from the start of the boost phase until a predetermined peak current is achieved. The achievement of the peak current is then directly followed in a known fashion by a reduction in the current intensity. The time range within which the current intensity is reduced is also referred to as the freewheeling phase. If appropriate, at least in the case of relatively large fuel quantities which are to be injected and which require a relatively long period of opening of the fuel injector, the freewheeling phase can also be followed by what is referred to as a holding phase within which the fuel injector is held in its open position by a sufficiently large holding current, which results in a sufficiently large magnetic holding force.

The determination of the rise time can be carried out directly by means of suitable current regulator hardware which is used to generate the electrical excitation of the coil. However, a suitable separate current measuring device can also be used, which current measuring device has, for example, an analog/digital converter.

The electrical excitation of the coil can be, in particular, the electrical voltage.

It is to be noted that the third electrical excitation profile can, of course, be used not only for the third multiple injection but also for further multiple injections. This means that the electrical excitation profiles of further multiple injections for each partial injection process then also bring about the described shortest possible boost phase and therefore effective approximation of the injection quantities for each partial injection process of the further multiple injections.

According to one embodiment, the third electrical excitation profile for each partial injection process comprises equally long electrical actuation (Ti) which starts with the start of the respective boost phase. This ensures that after the end of the boost phase which, according to the invention, is equally long for all the partial injection processes, no undesired variations in the injection quantities occur owing to the time periods in which the fuel injector is completely opened having different lengths.

The electrical actuation of the fuel injector or of the coil of the coil drive of the fuel injector therefore starts together with the boost phase and, in addition to the freewheeling phase whose start is triggered by the achievement of the predefined peak current or maximum current, it can, if appropriate, also still have a typically very short holding phase. The time periods of the pre-charge phase which are contained in the third electrical excitation profile are therefore not assigned to the actual electrical actuation. The excitation in the pre-charge phases is in fact so short that it is ensured that opening of the fuel injector does not occur (yet).

The electrical actuation is preferably implemented by means of an actuation voltage with which the coil of the coil drive of the coil injector is supplied in the respective time period.

In this context it is also the case that the feature of the equally long electrical actuations also applies to further electrical excitation profiles following the third electrical excitation profile.

According to a further embodiment, the electrical excitation during the respective pre-charge phase is also dimensioned in such a way that at the time of the end of the electrical actuation for each partial injection process, said actuation being equally long for each partial injection process, an equally high residual current level of the profile of the current through the coil is provided.

The coil drive therefore has at the end of each partial injection process in each case the same residual magnetization which, to put it clearly, can be considered to be a residual quantity of energy which remains in the coil drive and which, under certain circumstances, decreases, for example, exponentially over time. If a certain (magnetic) residual quantity of energy is still contained in the coil drive at the time of the start of the next electrical excitation for the following partial injection process, less energy is correspondingly then required for the next partial injection process in order to implement the desired opening process. The residual current level therefore has, in particular in the case of small separation times between successive partial injection processes, an influence not only on the closing behavior of the fuel injector but also on the opening behavior of the subsequent partial injection process of the fuel injector.

The compliance with the same residual current level therefore has the advantage that not only the closing behavior but also the opening behavior for various partial injection processes can be approximated to one another. Consequently, particularly accurate approximation of the quantities of the fuel which is injected by the various partial injection processes can be implemented.

According to a further embodiment, the separation time between two successive electrical actuations (Ti), which are equally long, in the third electrical excitation profile is equal to the minimum possible separation time calculated for the second multiple injection.

The described third multiple injection is therefore carried out with the minimum possible separation time. As a result, the energetic and/or magnetic influences which act from a preceding partial injection process on the directly following partial injection process are defined accurately and can be compensated with respect to optimum quantity approximation of the fuel quantities injected with each partial injection process, by means of the dimensioning of the electrical excitation described above, during the respective pre-charge phase.

According to a further embodiment, the determination of the closing time of the fuel injector for the first partial injection process occurs by means of an evaluation of electrical signals which are present at the coil.

The determination of the closing time can be based, for example, on the effect that after the switching off of the current flow or the actuation current the closing movement of a magnet armature and of a valve needle, connected thereto, of the coil drive causes the voltage present at the coil (injector voltage) to be influenced as a function of the speed. In the case of a coil-driven valve there is in fact a reduction in the magnetic force after the switching off of the actuation current. Owing to a spring prestress and a hydraulic force present at the valve (caused for example by a fuel pressure) there is a resulting force which accelerates the magnetic armature and the valve needle in the direction of the valve seat. The magnet armature and valve needle reach their maximum speed immediately before the impact on the valve seat. With this speed, the air gap between a core of the coil and the magnet armature then also increases. Owing to the movement of the magnet armature and the associated increase in the air gap, the residual magnetization of the magnet armature brings about a voltage induction in the coil. The maximum occurring movement induction voltage then characterizes the maximum speed of the magnet needle and therefore the time of the mechanical closing of the valve.

The voltage profile of the voltage which is induced in the currentless coil is therefore at least partially determined by the movement of the magnet armature. As a result of a suitable evaluation of the time profile of the voltage induced in the coil, the proportion which is based on the relative movement between the magnet armature and the coil can be determined at least in a good approximation. In this way, information about the movement profile can also be acquired automatically, which information permits accurate conclusions to be drawn about the time of the maximum speed and therefore also about the time of the closing of the valve.

According to a further embodiment, the electrical excitation during the respective pre-charge phase comprises supplying the coil with a voltage which is made available by a battery of the motor vehicle. This has the advantage that for the electrical excitation during the respective pre-charge phase it is possible to have recourse to a voltage level which is present in any case in the motor vehicle. If the voltage made available by the battery is too high for optimum dimensioning of the electrical excitation during the respective pre-charge phase, two-point regulation, for example by means of pulse width modulation, can then also be used to make available in easy fashion effectively reduced electrical excitation during the respective pre-charge phase.

According to a further embodiment, the electrical excitation at least during the start of the respective pre-charge phase comprises supplying the coil with a boost voltage which is increased compared to the voltage made available by a battery of the motor vehicle. This has the advantage that sufficient and suitable pre-magnetization of the coil drive can be achieved even with a shortened pre-charge phase. Of course, it is necessary to bear in mind here that the time period of the application of the boost voltage is so short that undesired opening of the fuel injector does not already occur during the pre-charge phase.

The boost voltage which is applied to the coil of the coil drive of the fuel injector during the respective pre-charge phase can be the same boost voltage or another boost voltage (of a different magnitude) which is applied to the coil during the boost phase until the predefined maximum peak current is achieved.

According to a further embodiment, the supplying of the coil with the first electrical excitation profile is carried out at the start of a driving cycle of the motor vehicle. This has the advantage that the subsequent determination of the closing time of the fuel injector and the calculation of the minimum possible separation time takes place between two successive partial injection processes of the second multiple injection on the basis of defined operating conditions of the fuel injector. In particular, it can be assumed that the temperature of the fuel injector at the start of a driving cycle is significantly lower than at a time at which the fuel injector and, if appropriate, also the internal combustion engine, on which the fuel injector is mounted has already been operational for a certain time. In this context it is specifically significant that in known fashion the rise time of the current intensity until the predefined peak current is achieved depends, inter alia, on the temperature T of the fuel injector. In particular, the minimum rise time which can be achieved becomes longer as the temperature T rises.

Therefore, the start of a driving cycle, for example after the motor vehicle has been shut down for at least a certain time, is suitable in a particular way for determining the shortest rise time which can physically occur in the fuel injector. This ensures that all the rise times of the current intensity which occur later during the respective boost phase, i.e. until the predefined peak current is achieved, are longer than or equal to the minimum rise time which can be achieved by the respective fuel injector, which minimum rise time later determines the equalized current intensity rise times of the various partial injection processes.

To put it clearly, in the case of the exemplary embodiment described here the minimum rise time which can be achieved and which is used for the later adjustment of the current signals for the individual partial injection processes is determined under generally still “cold” temperature conditions for the fuel injector. In this context, it can be assumed that during a driving cycle of the internal combustion engine the fuel injector temperatures which occur are always higher than the starting temperature. Further driving cycles can, if appropriate, request a comparison of the starting temperature, for example, with the coolant temperature of the last driving cycle, in order thereby to determine successively the minimum fuel injector temperature.

At this point it is to be noted that the current profile until the predefined peak current and in particular also the rise time are achieved also depend on the (electrical) separation time between the electrical actuations Ti for two successive partial injection processes. In particular, the rise time becomes shorter as the (electrical) separation time decreases.

According to a further embodiment, the method also comprises determining the closing time of the fuel injector for the first partial injection process of the third or of a further multiple injection. If the determined closing time of the fuel injector for the first partial injection process of the third or of a further multiple injection occurs earlier than the determined closing time of the fuel injector for the first partial injection process of the first multiple injection, the method specified with this exemplary embodiment then also comprises (a) calculating, for a subsequent multiple injection, an updated minimum possible separation time between (i) the end of the electrical excitation for a first partial injection process and (ii) the start of the electrical excitation for a subsequent second partial injection process, in which the fuel injector still just completely closes between the two partial injection processes, (b) supplying the coil with a subsequent electrical excitation profile which brings about the subsequent multiple injection with at least the first partial injection process and the second partial injection process, (c) determining an updated rise time of the current intensity during the boost phase of the second partial injection process of the subsequent multiple injection, (d) identifying the determined updated rise time as an updated minimum rise time which can be achieved by the respective fuel injector, and (e) supplying the coil with a further subsequent electrical excitation profile which brings about a further subsequent multiple injection with at least two partial injection processes. In this context, the further subsequent electrical excitation profile for each partial injection process comprises a further subsequent pre-charge phase by means of which the coil drive is pre-magnetized. In addition, the electrical excitation during the respective further subsequent pre-charge phase is dimensioned in such a way that the rise times within the further subsequent electrical excitation profile for the boost phases of the at least two partial injection processes of the further subsequent multiple injection are at least approximately the same as the identified updated minimum rise time.

To put it clearly, this can mean that on the basis of a further determination of the closing time of the fuel injector for the first partial injection process of the third or of a further multiple injection, further optimization of the equalization of the current (partial) profiles for the various partial injection processes of at least one further subsequent multiple injection can be carried out. If it should in fact turn out that owing to a closing process which has become quicker, in future a still shorter separation time (=updated minimum possible separation time) is possible, this updated minimum possible separation time, an updated minimum rise time which is based thereon and suitably dimensioned further subsequent pre-charge phases can then be used for the further operation of the fuel injector in order to achieve even better equalization of the current (partial) profiles for the various partial injection processes of further subsequent multiple injections.

As already explained above, these current (partial) profiles can bring about, in particular, rise times of the current profile which are uniform and as short as possible, during the respective boost phases. These current (partial) profiles can preferably additionally bring about residual current levels which are of equal magnitude and preferably as low as possible and which in turn result in a reduced residual magnetization of the coil drive at the end of a respective actuation for a partial injection process.

Another embodiment provides a device for adapting the time profile of a current is described, which current flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least one boost phase and one freewheeling phase. The described device comprises (a) a current regulating device (i) for supplying the coil with a voltage and (ii) for regulating the current flowing through the coil, and (b) a data processing unit which is coupled to the current regulating device. The current regulating device and the data processing unit are configured to carry out the abovementioned method.

The steps of supplying the coil with the respective electrical excitation profile are preferably decisively carried out by the current regulating device. The steps (a) of determining the closing time, (b) of calculating the minimum possible separation time, (c) of determining the rise time of the current intensity, (d) of identifying the determined rise time as a minimum rise time which can be achieved by the respective fuel injector and (e) of suitably dimensioning the electrical excitation during the respective pre-charge phase are preferably carried out by the data processing unit.

Another embodiment provides an engine controller for an internal combustion engine of a motor vehicle is described. The engine controller comprises a device of the abovementioned type for adapting the time profile of a current which flows through a coil of a coil drive of a fuel injector.

Another embodiment provides a computer program for adapting the time profile of a current is described, which current flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least one boost phase and one freewheeling phase. The computer program is configured, when executed by a processor, to carry out the abovementioned method.

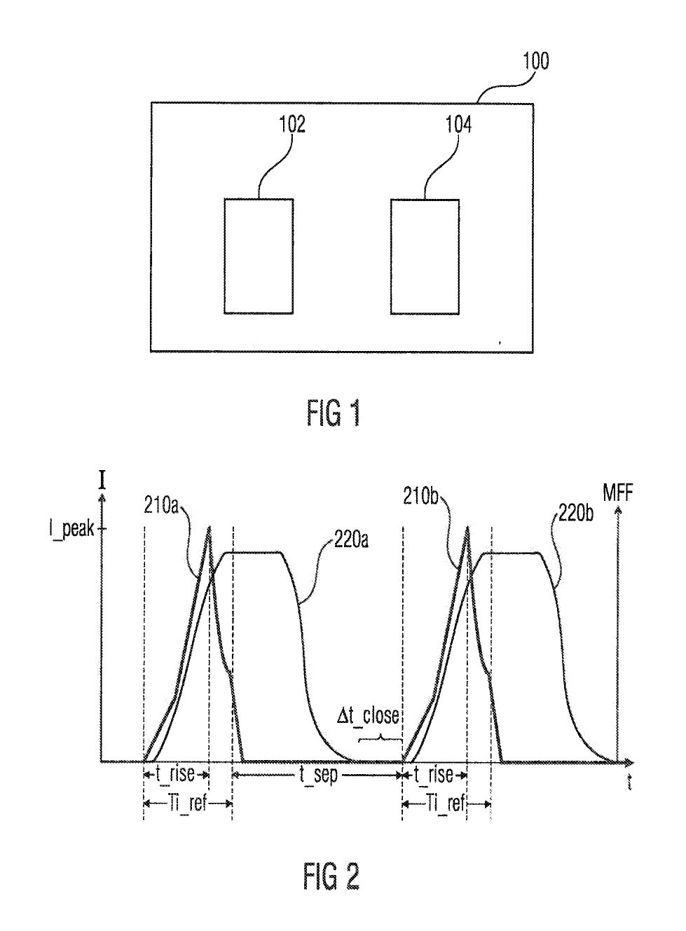

FIG. 1 shows, according to an exemplary embodiment of the invention, a device 100 for adapting the time profile of a current which flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least one boost phase and one freewheeling phase. The device 100 has a current regulating device 102 and a data processing unit 104. The current regulating device 102 and the data processing unit 104 are configured to carry out a method for adapting the time profile of a current which flows through the coil and which brings about, during the operation of the internal combustion engine, a multiple injection of fuel with at least two partial injection processes. In this context, the time profile of the current for each partial injection process comprises at least one boost phase and one freewheeling phase. The adaptation method comprises the following steps:

(A) supplying the coil with a first electrical excitation profile which brings about a first multiple injection in which two successive partial injection processes are chronologically separated from one another to such an extent that the fuel injector closes completely between the two partial injection processes,
(B) determining the closing time of the fuel injector for the first partial injection process of the first multiple injection,
(C) calculating, for a second multiple injection, a minimum possible separation time between (i) the end of the electrical excitation for a first partial injection process and (ii) the start of the electrical excitation for a subsequent second partial injection process, wherein the fuel injector just still completely closes between the two partial injection processes,
(D) supplying the coil with a second electrical excitation profile which brings about the second multiple injection with at least the first partial injection process and the second partial injection process,
(E) determining the rise time of the current intensity during the boost phase of the second partial injection process of the second multiple injection,
(F) identifying the determined rise time as a minimum rise time which can be achieved by the respective fuel injector, and
(G) supplying the coil with a third electrical excitation profile which brings about a third multiple injection with at least two partial injection processes, wherein (i) the third electrical excitation profile for each partial injection process comprises a pre-charge phase by means of which the coil drive is pre-magnetized, and wherein (ii) the electrical excitation is dimensioned during the respective pre-charge phase in such a way that the rise times within the third electrical excitation profile for the boost phases of the at least two partial injection processes of the third multiple injection are at least approximately the same as the identified minimum rise time. Even if the current regulating device 102 and the data processing unit 104 cooperate suitably, the steps (A), (D) and (G) are decisively carried out by the current regulating device 102, and the steps (B), (C), (E) and (F) are decisively carried out by the data processing unit 104.

The objective of the present invention is to approximate, through suitable pre-magnetization, the time current profile for the individual current partial profiles which are each assigned to a partial injection process of a multiple injection, independently of temperature, inductivity and electrical separation time, and therefore to minimize the variations in the opening period of the fuel injector for the various partial injection processes.

Even in the case of short injection times, the peak currents which are characteristic of the respective boost phase are typically achieved. In the subsequent phases of commutation to the off state (freewheeling phase), the current is switched off. As a result of the approximation of the currents, described in this document, in the switch-off phase, it is possible to switch off or commutate to the off state, during respectively identical injection times of the same residual current level (at the end of the actual electrical actuation). This brings about, as a result of the now identical demagnetization conditions, less variation in the closing behavior of the fuel injector.

In order to be able to implement equalization of the current rise times for the individual partial injection processes by means of active pre-magnetization, according to the method described in this document the shortest rise time t_rise_min of the current is firstly determined by the fuel injector until a predefined peak current I_peak which can occur physically in the coil of the coil drive of the fuel injector is achieved. It is therefore possible to ensure that all the current rise times t_rise which occur themselves are at least of equal length or longer than the shortest rise time t_rise_min which later is to be the equalized current rise time for all the partial injection processes.

The current rise time t_rise becomes shorter as the injector temperature drops and as the separation time t_sep between the electrical actuations Ti for the individual partial injection processes decreases. Accordingly, according to the exemplary embodiment described here for the adjustment in an early phase of the start of injection the shortest possible rise time t_rise_min is generally determined under still “cold” temperature conditions for the fuel injector.

It is assumed here that during a driving cycle of the internal combustion engine the temperatures of the fuel injector which occur are always higher than the starting temperature. Further driving cycles can require, under certain circumstances, a respective comparison of the starting temperature, for example with the coolant temperature of the previous driving cycle, in order thereby to determine successively the minimum temperature of the fuel injector.

In order to achieve the shortest possible current rise time t_rise_min, it is necessary, as described above, to minimize the separation time t_sep between two successive electrical actuations Ti for two successive partial injection processes. In order in the process to avoid unstable operation of the multiple injection of the fuel injector, it is necessary, however, to ensure that the fuel injector closes for a minimum time between the two partial injection processes. In order to be able to set the electrical actuations Ti in an optimum way with respect to these conditions, it is necessary, however, to know the closing periods of the fuel injector. In this context the closing period is that time period which the fuel injector requires to completely stop the fuel input MFF after the end of the electrical actuation Ti.

The closing period of the fuel injector is determined according to the exemplary embodiment presented here in an operating state of the fuel injector in such a way that two electrical actuations during in each case one time period Ti_ref of the fuel injector are spaced apart chronologically from one another to such an extent that between two directly successive partial injection processes the fuel injector is completely closed at least for a certain time period Δt_close.

FIG. 2 shows this operating state. Two electrical actuations by means of in each case one voltage time profile (not illustrated) during the two time periods Ti_ref each bring about a current flow I through the coil of the coil drive of the fuel injector. The separation time between the two successive electrical actuations in the time periods Ti_ref is characterized by t_sep in FIG. 2.

A first current flow 210a through the coil brings about a first fuel input 220a. The rise time of the first current flow 210a up to a predetermined peak current I_peak, the achievement of which marks in a known fashion the end of the boost phase, is characterized in FIG. 2 by t_rise. A second current flow 210b through the coil brings about a second fuel input 220b. The rise time of the second current flow 210b up to the peak current I_peak is also characterized by t_rise in FIG. 2. Owing to the large time interval between the two electrical actuations in the time periods Ti_ref, the profiles for the two currents 210a and 210b are at least approximately the same. The same applies to the profiles of the two resulting fuel inputs 220a and 220b, which are also at least approximately the same.

In order to determine the closing time of the fuel injector, various known methods can be applied. However, preferably a method is applied which is merely based on an evaluation of electrical signals which are present at the coil. As already explained above, the determination of the closing time can be based on the effect that after the switching off of the current flow or the actuation current the closing movement of a magnet armature and a valve needle, connected thereto, of the coil drive brings about speed-dependent influencing of the voltage present at the coil (injector voltage). Immediately before the impacting on the valve seat, the magnet armature and the valve needle reach their maximum speed. With this speed the air gap between a core of the coil and the magnet armature then also becomes larger. Owing to the movement of the magnet armature and the associated increase in the air gap, the remanent magnetism of the magnet armature brings about a voltage induction in the coil. The maximum occurring movement induction voltage characterizes then the maximum speed of the magnet needle and therefore the time of the mechanical closing of the valve.

On the basis of knowledge of the actual closing period of the fuel injector, the separation time between two successive electrical actuations Ti_ref up to a minimum separation time t_sep_min between two successive electrical actuations Ti_ref can then be shortened. The minimum separation time t_sep_min is still just of such a length that the fuel injector is completely closed only for a short time.

To put it clearly, this means that after knowledge of the actual time of closing of the fuel injector, a dual injection or multiple injection with a minimum electrical separation time t_sep_min is set. Ideally, a requested time current pulse (corresponds to a defined requested fuel quantity input Q_setp) can be divided here into two directly successive chronological pulses of the respective energization period Ti_ref (corresponding sum input Q_setp), in order to keep the change in reaction at the internal combustion engine as small as possible during the adaptation which is described here.

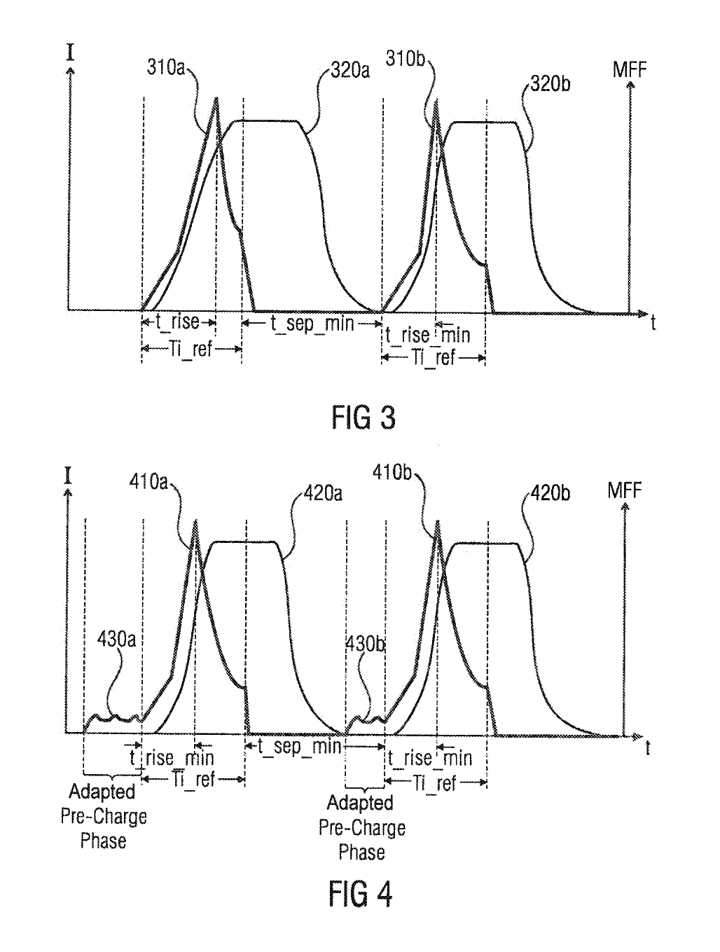

FIG. 3 shows the electrical actuation of the fuel injector with the minimum separation time t_sep_min and the resulting fuel inputs. A first current flow 310a through the coil brings about a first fuel input 320a. A second current flow 310b through the coil brings about a second fuel input 320b. It is apparent that (owing to residual magnetization of the armature of the coil drive) the (now minimal) rise time t_rise_min of the second current flow is significantly shorter than the rise time t_rise of the first current flow 310a. From FIG. 3 it is also apparent that at the end of the electrical actuation during Ti_ref the residual current level of the first current flow 310a is significantly higher than the residual current level of the second current flow 310b. In addition, the curve area under the profile of the first fuel input 320a is larger than the curve area under the profile of the second fuel input 320b.

In the adaptation method described here, current regulator hardware or a separate chronological current measuring method determines the minimum rise time t_rise_min of the current through the fuel injector, which occurs in the operating state in FIG. 3. The objective is now to set this measured minimum rise time t_rise_min for all the further partial injection processes by means of a regulating algorithm.

According to the exemplary embodiment illustrated here, this regulating algorithm sets pre-magnetization. This is done with a pre-charge phase which is located chronologically directly before the respective boost phase. The pre-charge phase can be regulated chronologically in length and in terms of its current intensity. The pre-magnetization of the fuel injector must, however, not bring about premature opening of the fuel injector during the pre-charge phase.

The regulation is carried out according to the exemplary embodiment illustrated here by incremental approximation to t_rise_min by incrementally changing the effective value of the current and/or the duration of the pre-charge phase. Ideally, the voltage supply which is necessary for energization is obtained from the battery of the system. However, other voltages, for example a specific boost voltage, can also be used for the pre-charge phase. The system can learn the necessary pre-charge phase as a function of the timing of the individual injection pulse and can, if appropriate, determine a new value for t_rise_min under relatively low cold starting conditions, and therefore trigger renewed adaptation of the current profile.

It is also possible to reduce the already adapted minimum rise time t_rise_min further (i.e. to shorten the opening duration of the fuel injector) by setting the pre-charge phase of the second pulse incrementally to zero (after the equalization described here).

FIG. 4 shows a time profile of a current I through a coil drive of a fuel injector, wherein equalization of the individual partial injection processes in relation to the respective fuel inputs is achieved by means of adapted pre-charge phases 430a and 430b before the actual electrical actuation of the coil drive. A first current flow 410a through the coil brings about a first fuel input 420a. A second current flow 410b through the coil brings about a second fuel input 420b.

From FIG. 4 it is clearly apparent that (owing to the two different adapted pre-charge phases 430a and 430b) the two current profiles 410a and 410b and, in particular, their rise times t_rise_min as well as their residual current levels are at least approximately identical at the end of the respective electrical actuation in the time period Ti_ref. The same applies to the resulting injected fuel quantities which are obtained from the integral (curve area) over the respective profile of the fuel input 420a and 420b.

### LIST OF REFERENCE SYMBOLS

100 Device for adapting the time profile of a current/engine controller
102 Current regulating device
104 Data processing unit
210a/b Current through the coil of a coil drive of a fuel injector
220a/b Resulting fuel input
I Current through the fuel injector
MFF Fuel input
t Time
I_peak Peak current
t_rise Rise time of the current through the fuel injector
Ti_ref Electrical actuation of the coil drive
t_sep Separation time between two successive electrical actuations Ti_ref
Δt_close Time period within which the fuel injector is completely closed
310a/b Current through the coil of a coil drive of a fuel injector
320a/b Resulting fuel input
t_sep_min Minimum separation time between two successive electrical actuations Ti_ref
t_rise_min Minimum rise time of the current through the fuel injector
410a/b Current through the coil of a coil drive of a fuel injector
420a/b Resulting fuel input
430a/b Adapted pre-charge phases

What is claimed is:

1. A method for adapting a time profile of a current which flows through a coil of a coil drive of a fuel injector and which brings about multiple injection of fuel with at least two partial injection processes during the operation of an internal combustion engine of a motor vehicle, wherein the time profile of the current for each partial injection process comprises at least one boost phase and one freewheeling phase, the method comprising:
supplying the coil with a first electrical excitation profile that causes a first multiple injection in which two successive partial injection processes are chronologically separated from one another to such an extent that the fuel injector closes completely between the two partial injection processes,
determining a closing time of the fuel injector for the first partial injection process of the first multiple injection,
calculating, for a second multiple injection, a minimum possible separation time between (i) an end of an electrical excitation for a first partial injection process and (ii) a start of an electrical excitation for a subsequent second partial injection process, wherein the fuel injector just still completely closes between the two partial injection processes,
supplying the coil with a second electrical excitation profile that causes the second multiple injection with at least the first partial injection process and the second partial injection process,
determining a rise time of the current intensity during a boost phase of the second partial injection process of the second multiple injection,
identifying the determined rise time as a minimum rise time achievable by the respective fuel injector, and
supplying the coil with a third electrical excitation profile that causes a third multiple injection with at least two partial injection processes,
wherein the third electrical excitation profile for each partial injection process comprises a pre-charge phase that pre-magnetizes the coil drive, and
wherein the electrical excitation is dimensioned during the respective pre-charge phase such that the rise times within the third electrical excitation profile for the boost phases of the at least two partial injection processes of the third multiple injection correspond with the identified minimum rise time.

2. The method of claim 1, wherein the third electrical excitation profile for each partial injection process comprises equally long electrical actuation which starts with the start of the respective boost phase.

3. The method of claim 2, wherein the electrical excitation during the respective pre-charge phase is also dimensioned such that at the time of the end of the electrical actuation for each partial injection process, said actuation being equally long for each partial injection process, an equally high residual current level of the profile of the current through the coil is provided.

4. The method of claim 2, wherein the separation time between two successive electrical actuations, which are equally long, in the third electrical excitation profile is equal to the minimum possible separation time calculated for the second multiple injection.

5. The method of claim 1, wherein the determination of the closing time of the fuel injector for the first partial injection process comprises an evaluation of electrical signals which are present at the coil.

6. The method of claim 1, wherein the electrical excitation during the respective pre-charge phase comprises supplying the coil with a voltage provided by a battery of the motor vehicle.

7. The method of claim 1, wherein the electrical excitation at least during the start of the respective pre-charge phase comprises supplying the coil with a boost voltage which is increased compared to the voltage provided by a battery of the motor vehicle.

8. The method of claim 1, wherein the supplying of the coil with the first electrical excitation profile is performed at the start of a driving cycle of the motor vehicle.

9. The method of claim 1, further comprising:
determining the closing time of the fuel injector for the first partial injection process of the third or of a further multiple injection, and
if the determined closing time of the fuel injector for the first partial injection process of the third or of a further multiple injection occurs earlier than the determined closing time of the fuel injector for the first partial injection process of the first multiple injection, calculating, for a subsequent multiple injection, an updated minimum possible separation time between (a) the end of the electrical excitation for a first partial injection process and (b) the start of the electrical excitation for a subsequent second partial injection process, in which the fuel injector still just completely closes between the two partial injection processes,
supplying the coil with a subsequent electrical excitation profile that causes the subsequent multiple injection with at least the first partial injection process and the second partial injection process,
determining an updated rise time of the current intensity during the boost phase of the second partial injection process of the subsequent multiple injection,
identifying the determined updated rise time as an updated minimum rise time which can be achieved by the respective fuel injector, and
supplying the coil with a further subsequent electrical excitation profile that causes a further subsequent multiple injection with at least two partial injection processes,
wherein the further subsequent electrical excitation profile for each partial injection process comprises a further subsequent pre-charge phase that pre-magnetizes the coil drive, and
wherein the electrical excitation during the respective further subsequent pre-charge phase is dimensioned in such a way that the rise times within the further subsequent electrical excitation profile for the boost phases of the at least two partial injection processes of the further subsequent multiple injection correspond with the identified updated minimum rise time.

10. (canceled)

11. An engine controller for an internal combustion engine of a motor vehicle, the engine controller comprising:
a device for adapting the time profile of a current which flows through a coil of a coil drive of a fuel injector and which brings about, during the operation of an internal combustion engine of a motor vehicle, a multiple injection of fuel with at least two partial injection processes, wherein the time profile of the current for each partial injection process comprises at least one boost phase and one freewheeling phase, the device comprising:
a current regulating device configured to (a) supply the coil with a voltage and (b) regulate the current flowing through the coil, and
a data processing unit coupled to the current regulating device, wherein
the current regulating device and the data processing unit are configured to perform a method comprising:
supplying the coil with a first electrical excitation profile that causes a first multiple injection in which two successive partial injection processes are chronologically separated from one another to such an extent that the fuel injector closes completely between the two partial injection processes,
determining a closing time of the fuel injector for the first partial injection process of the first multiple injection,
calculating, for a second multiple injection, a minimum possible separation time between (i) an and of an electrical excitation for a first partial injection process and (ii) a start of an electrical excitation for a subsequent second partial injection process, wherein the fuel injector still completely closes between the two partial injection processes,
supplying the coil with a second electrical excitation profile that causes the second multiple injection with at least the first partial injection process and the second partial inject on process,
determining a rise time of the current intensity during a boost phase of the second partial injection process of the second multiple injection,
identifying the determined rise time as a minimum rise time achievable by the respective fuel injector, and
supplying the coil with a third electrical excitation profile that causes a third multiple injection with at least two partial injection processes,
wherein the third electrical excitation profile for each partial injection process comprises a pre-charge phase that pre-magnetizes the coil drive, and
wherein the electrical excitation is dimensioned during the respective pre-charge phase such that the rise times within the third electrical excitation profile for the boost phase of the at least two partial injection processes of the third multiple injection correspond with the identified minimum rise time.

12. (canceled)

13. The engine controller of claim 11, wherein the third electrical excitation profile for each partial injection process comprises equally long electrical actuation which starts with the start of the respective boost phase.

14. The engine controller of claim 13, wherein the electrical excitation during the respective pre-charge phase is also dimensioned such that at the time of the end of the electrical actuation for each partial injection process, said actuation being equally long for each partial injection process, an equally high residual current level of the profile of the current through the coil is provided.

15. The engine controller of claim 13, wherein the separation time between two successive electrical actuations, which are equally long, in the third electrical excitation profile is equal to the minimum possible separation time calculated for the second multiple injection.

16. The engine controller of claim 11, wherein the determination of the closing time of the fuel injector for the first partial injection process comprises an evaluation of electrical signals which are present at the coil.

17. The engine controller of claim 11, wherein the electrical excitation during the respective pre-charge phase comprises supplying the coil with a voltage provided by a battery of the motor vehicle.

18. The engine controller of claim 11, wherein the electrical excitation at least during the start of the respective pre-charge phase comprises supplying the coil with a boost voltage which is increased compared to the voltage provided by a battery of the motor vehicle.

19. The engine controller of claim 11, wherein the supplying of the coil with the first electrical excitation profile is performed at the start of a driving cycle of the motor vehicle.
